(19) United States
(12) Patent Application Publication
(10) Pub. No.: US 2010/0047611 A1
(43) Pub. Date: Feb. 25, 2010

(54) NANOPOROUS TITANIUM OXIDE AND METHOD FOR PREPARING THE SAME

(76) Inventor: Seo-Yong Cho, Seoul (KR)

Correspondence Address: SEO-YONG CHO;ICHON YONGSAN, 2-711, SMAICK APT, SEOUL, 137-728, KR

(21) Appl. No.: 12/197,525

(22) Filed: Aug. 25, 2008

(51) Int. Cl. B32B 5/18; B05D 3/14; B32B 5/00; B32B 3/00; B01J 23/00

(52) U.S. Cl. 428/613; 427/532; 428/98; 428/315.5; 502/350

(57) ABSTRACT

A method of preparing a nanoporous titanium film includes depositing a film of a mixture including titanium and one or more metals that are immiscible with the titanium on a substrate; and eliminating the one or more metals that are immiscible with the titanium selectively from the mixture by an electrochemical method. A method of preparing a nanoporous TiO₂ film includes depositing a film of a mixture including titanium and one or more metals that are immiscible with the titanium on a substrate; eliminating the one or more metals that are immiscible with the titanium selectively from the mixture by an electrochemical method; and oxidizing the titanium.

### BACKGROUND

Nanoporous titanium oxide has been used for photocatalyst and photoelectrode. Various methods of preparing nanopotous titanium oxide (ex. sol-gel method, ethylene glycol method, hydrothermal synthesis method and so on) have been reported. However, the reported methods are not compatible to mass-production with low cost, because it can be complicated, expensive and requiring multiple preparation steps.

### SUMMARY

In one aspect, a method is provided including preparing a nanoporous titanium film including depositing a film of a mixture comprising titanium and one or more metals that are immiscible with the titanium on a substrate; and eliminating the one or more metals that are immiscible with the titanium selectively from the mixture by an electrochemical method. In other embodiments, the one or more metals that are immiscible with titanium are Al, Fe, Co, Ni, Mg, Ca, or a mixture of any two or more thereof. In other embodiments, the one or more metals that are immiscible with titanium is Mg. In other embodiments, the one or more metals that are immiscible with titanium is Ca. In other embodiments, the one or more metals that are immiscible with titanium is Al.

In other embodiments, the film of the mixture includes 70 wt % or more of titanium. In other embodiments, the electrochemical method includes using the film as an electrode.

In another aspect, a method is provided including preparing a nanoporous TiO₂ film including depositing a film of a mixture including titanium and one or more metals that are immiscible with the titanium on a substrate; eliminating the one or more metals that are immiscible with the titanium selectively from the mixture by an electrochemical method; and oxidizing the titanium. In some embodiments, the one or more metals that are immiscible with the titanium are Al, Fe, Co, Ni, Mg, Ca, or a mixture of any two or more thereof. In some embodiments, the one or more metals that are immiscible with the titanium are Mg. In some embodiments, the one or more metals that are immiscible with the titanium are Ca. In some embodiments, the one or more metals that are immiscible with the titanium are Al.

In some embodiments, the film of the mixture has 70 wt % or more of Ti.

In some embodiments, the electrochemical method includes using the film as an electrode. In other embodiments, the oxidizing the titanium metal includes thermal oxidation. In yet other embodiments, the thermal oxidation comprises heating at a temperature of 400° C. or higher. In further embodiments, the oxidizing titanium metal comprises electrochemical oxidation. In yet further embodiments, the electrochemical oxidation includes using an anode having a reduction potential higher than titanium.

In another aspect, nanoporous Ti films are obtained by any of the described methods.

In another aspect, nanoporous TiO₂ films are obtained by any of the described methods.

In another aspect, an artificial bone includes a nanoporous Ti film.

In another aspect, a photoelectrode includes a nanoporous TiO₂ film. In some embodiments, an energy conversion device includes the photoelectrode.

In another aspect, a photocatalyst includes a nanoporous TiO₂ film.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a method for preparing a nanoporous TiO₂ film according to one embodiment.

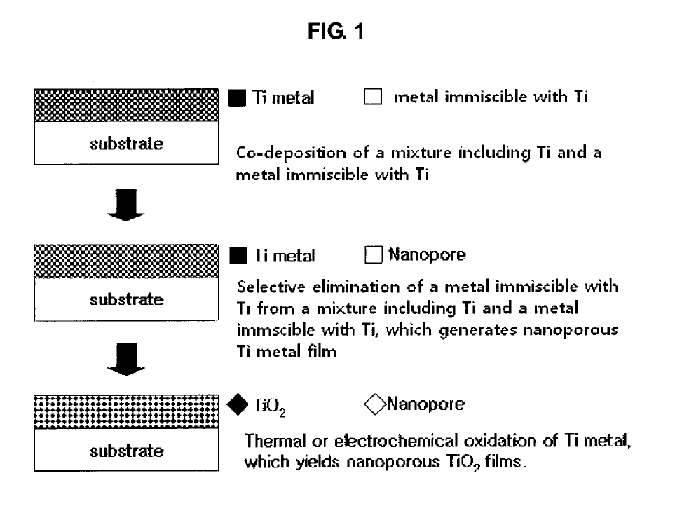

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the figures, may be arranged, substituted, combined, and designed in a wide variety of different configurations, all of which are explicitly contemplated and make part of this disclosure.

In one aspect, a method is provided for preparing a nanoporous Ti film. The method includes depositing a film of a mixture of titanium (Ti) and a metal that is immiscible with Ti, followed by selectively eliminating the metal that is immiscible with Ti from the mixture. After removal of the metal that is immiscible with the Ti, the remaining material is a Ti film that is nanoporous due to the vacancies left by the removal of the other metal.

The mixture may be deposited by any of a number of methods. In one example, the mixture is co-deposited using methods such as cold spray, sputtering, or chemical vapor deposition (CVD).

As used herein, “cold spray” refers to methods that use a gas flow of precursors to the deposited materials. In principle, corpuscles of Ti, and a metal that is immiscible with Ti, to be deposited are carried on supersonic gas flow at a speed of about mach 1.5 to mach 2 before impinging on a substrate. The coating (or film) then forms as the metals stick to the substrate surface.

As used herein, CVD is a method of deposition that uses heating of the metal precursors to a vapor where the precursor decomposes and the metal is deposited. In some examples, a boat of the precursor are subjected to an electron beam or a filament, under high vacuum (i.e. about 5×10⁻⁵ to 1×10⁻⁷ torr). The metal or precursor is then melting and distilled whereupon the metal is allowed to condense on a cold substrate.

As used herein, sputtering uses a plasma to generate ions of the metals that can then adhere to a substrate. Plasmas may be formed by using a cathode shield under argon gas atmosphere; placing a source material such as Ti and a substrate on an opposite parallel plate connected to a high-voltage electricity in a chamber; evacuating the chamber; and then flowing a sputtering gas of a lower pressure within the chamber; applying voltage to the electrode thereby forming a plasma between the plates. The sputtering gas may be an inert gas such as hydrogen, nitrogen, helium, argon, or krypton. In the process, sputtering gas ions are accelerated to the plate covered with the source material because the plate covered with the source material maintains negative potential compared to the substrate. As the sputtering gas ion impacts the source material atoms of source material (i.e. Ti or other metals) are emitted and molecules of source material are deposited on the substrate.

In some embodiments, Ti and a metal that is immiscible with Ti are used as the sources for co-deposition. The term “immiscible with Ti” as used herein refers to a state that a metal other than Ti is physically mixed with Ti, but does not form an alloy with Ti. In other words, the atoms of the metal other than Ti do not replace or occupy a Ti site in the lattice structure of Ti. In the present disclosure, the metal that is immiscible with Ti is not limited, as long as the metal can be co-deposited with Ti and is immiscible with Ti. According to some embodiments, such metals include Fe, Co, Ni, Al, Mg, Ca, or a mixture of any two or more thereof.

In some embodiments, the nanoporous Ti films have nanopores that range in size from about 10 nm to about 50 μm. In some embodiments, the nanoporous Ti films have nanopores that range in size from about 10 nm to about 1 μm. In some embodiments, the nanoporous Ti films have nanopores that range in size from about 25 nm to about 500 nm.

In other embodiments, the Ti is present in the film of the mixture, (i.e. prior to removal of the metal that is immiscible with Ti) at from about 70 wt % or more of Ti.

For selective elimination of the metal other than Ti, and for the formation of nanopores in the Ti film, soaking methods or electrochemical methods may be used. Electrochemical methods allow for quick elimination of a metal and are effective in selectively eliminating the metal that is immiscible with Ti. In some embodiments, the electrochemical methods include using the deposited film as an electrode in a solution. A voltage is then applied to electrode that is capable of ionizing the metal that is immiscible with the Ti, but does not ionize the Ti. The solvent then is able to carry the metal ions from the electrode, leaving a nanoporous Ti film as the electrode.

In one embodiment, a method is provided for preparing a nanoporous Ti film by depositing a mixture including Ti and Al, followed by selectively eliminating Al from the mixture. The Ti and Al mixture may be co-deposited on a substrate according to any of the deposition methods described above. In some embodiments, the Ti in the Ti—Al mixture is present at a level of 70 wt % or more of Ti. From the Ti—Al mixture used in the present disclosure, Al may be electrochemically eliminated from the film by applying voltage using the Ti—Al mixture as a working electrode and Pt as a counter electrode, with a saturated calomel electrode (SCE) as a reference. In some embodiments, the electrochemical elimination is conducted in a basic electrolyte solution where NaOH or KOH are used to make the electrolyte basic. The concentration of NaOH or KOH is from about 0.1 M to 10 M, in some embodiments. For the Ti—Al mixture, the voltage for selective elimination is from about 1 V to 5 V, and the potential sweep rate is between 0.01 mV/s and 100 mV/s, in some embodiments. In other embodiments, for the Ti—Al mixture, the voltage for selective elimination is from about 1 V to 3 V, and the potential sweep rate is between 1 mV/s and 50 mV/s.

According to another embodiment, a method is provided for preparing a nanoporous Ti film including depositing a mixture of Ti and Mg, and subsequently selectively eliminating the Mg from the mixture. The mixture may be deposited according to the methods described herein. In some embodiments, the Ti in the Ti—Mg mixture is present at a level of 70 wt % or more of Ti. From the Ti—Mg mixture used in the present disclosure, Mg can be electrochemically eliminated by applying voltage using the Ti—Mg mixture as a working electrode and a Pt as a counter electrode, with a saturated calomel electrode (SCE) as a reference. In some embodiments, the electrochemical elimination is conducted in a basic electrolyte solution where NaOH or KOH are used to make the electrolyte basic. The concentration of NaOH or KOH is from about 0.1 M to 10 M, in some embodiments, or from about 0.2 M to 5 M in other embodiments. For the Ti—Mg mixture, the voltage for selective elimination is from about 1 V to 5 V, and the potential sweep rate is between 0.01 mV/s and 100 mV/s, in some embodiments. In other embodiments, for the Ti—Mg mixture, the voltage for selective elimination is from about 1 V to 3 V, and the potential sweep rate is between 1 mV/s and 50 mV/s.

According to another embodiment, a method is provided for preparing a nanoporous Ti film by depositing a mixture including Ti and Ca and subsequently selectively eliminating Ca from the Ti and Ca mixture. The mixture may be deposited according to the methods described herein. In some embodiments, the Ti in the Ti—Ca mixture is present at a level of 70 wt % or more of Ti. From the Ti—Ca mixture used in the present disclosure, Ca can be electrochemically eliminated by applying voltage using the Ti—Ca mixture as a working electrode and a Pt as a counter electrode, with a saturated calomel electrode (SCE) as a reference. In some embodiments, the electrochemical elimination is conducted in a basic electrolyte solution where NaOH or KOH are used to make the electrolyte basic. The concentration of NaOH or KOH is from about 0.1 M to 10 M, in some embodiments, or from about 0.2 M to 5 M in other embodiments. For the Ti—Ca mixture, the voltage for selective elimination is from about 1 V to 5 V, and the potential sweep rate is between 0.01 mV/s and 100 mV/s, in some embodiments. In other embodiments, for the Ti—Ca mixture, the voltage for selective elimination is from about 1 V to 3 V, and the potential sweep rate is between 1 mV/s and 50 mV/s.

The nanoporous Ti films have high surface area, due to the nanoporosity, and can be easily prepared. Hence, the materials are suitable for mass production and a variety of uses. Such nanoporous Ti films may be used where any Ti film is used in the art. For example, the nanoporous Ti film may be used as artificial bone and surgical instruments. In particular, the nanoporous Ti films tightly adhere to the human bone due to the nanoporous structure, thus rendering the films to be useful as artificial bones or as supports for bone structures.

In another aspect, the nanoporous Ti films may be oxidized to form TiO₂ films. The oxidation of Ti to TiO₂ can be carried out by any of a number of methods known to those of skill in the art. For example, the oxidation of Ti can be carried out by thermal oxidation or electric oxidation. The thermal oxidation is a method for oxidizing a metal by processing it with a high temperature, such as at a temperature of 400° C., or higher. The thermal oxidation may be carried out under air or oxygen supplied atmospherer than oxidation temperature may be followed by the conventional method published in the art.

The electric oxidation may be carried out by preparing a basic aqueous solution as an electrolyte in an electrolysis apparatus. The Ti film is then dipped into the electrolyte as a cathode, and a anode material having a reduction potential higher than that of Ti is used as an anode. After application of a voltage to the system, the Ti is oxidized to TiO₂.

Electrolytes include, any basic electrolyte conventionally used in the art, for example, Na₂HPO₄ aqueous solution may be unrestrictedly used in the present disclosure. The anode may be of any metal conventionally used in the art, as long as the metal has a reduction potential higher than that of Ti. In one embodiments, the anode is stainless steel. The voltage is not specifically restricted in the present disclosure as long as the voltage is sufficient to oxidize Ti to TiO₂.

According to the above oxidation methods, the nanoporous Ti is oxidized to a nanoporous TiO₂. The nanoporous TiO₂ has a relatively high surface area and can be easily prepared. Such materials are suitable for mass production and various uses.

The nanoporous TiO₂ films can be used wherever TiO₂ and nanoporous TiO₂ is conventionally used in the art. For example, the TiO₂ films can be used as photocatalysts for promoting photolysis reactions, as photocatalysts for the processing of waste water, photocatalysts for the preparation of hydrogen, as photocells, as catalysts, as catalysts by impregnating other catalyst materials into nanopores, and other uses as are known to those of skill in the art.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
preparing a nanoporous titanium film comprising:
depositing a film of a mixture comprising titanium and one or more metals that are immiscible with the titanium on a substrate; and
eliminating the one or more metals that are immiscible with the titanium selectively from the mixture by an electrochemical method.

2. The method of claim 1, wherein the one or more metals that are immiscible with titanium are Al, Fe, Co, Ni, Mg, Ca, or a mixture of any two or more thereof.

3. The method of claim 1, wherein the one or more metals that are immiscible with titanium is Mg.

4. The method of claim 1, wherein the one or more metals that are immiscible with titanium is Ca.

5. The method of claim 1, wherein the one or more metals that are immiscible with titanium is Al.

6. The method of claim 1, wherein the film of the mixture comprises 70 wt % or more of titanium.

7. The method of claim 1, wherein the electrochemical method comprises using the film as an electrode.

8. A method comprising:
preparing a nanoporous TiO₂ film comprising
depositing a film of a mixture comprising titanium and one or more metals that are immiscible with the titanium on a substrate;
eliminating the one or more metals that are immiscible with the titanium selectively from the mixture by an electrochemical method; and
oxidizing the titanium.

9. The method of claim 8, wherein the one or more metals that are immiscible with the titanium are Al, Fe, Co, Ni, Mg, Ca, or a mixture of any two or more thereof.

10. The method of claim 8, wherein the one or more metals that are immiscible with the titanium are Mg.

11. The method of claim 8, wherein the one or more metals that are immiscible with the titanium are Ca.

12. The method of claim 8, wherein the one or more metals that are immiscible with the titanium are Al.

13. The method of claim 8, wherein the film of the mixture comprises 70 w % or more of Ti.

14. The method of claim 8, wherein the electrochemical method comprises using the film as an electrode.

15. The method of claim 8, wherein the oxidizing the titanium metal comprises thermal oxidation.

16. The method of claim 15, wherein the thermal oxidation comprises heating at a temperature of 400° C. or higher.

17. The method of claim 8, wherein the oxidizing titanium metal comprises electrochemical oxidation.

18. The method of claim 17, wherein the electrochemical oxidation includes using an anode having a reduction potential higher than titanium.

19. A nanoporous Ti film obtained by the method according to any one of claim 1.

20. A nanoporous TiO₂ film obtained by the method according to any one of claim 8.

21. An artificial bone comprising a nanoporous Ti film prepared by the method according to any one of claim 1.

22. A photoelectrode comprising a nanoporous TiO₂ film prepared by the method according to any one of claim 8.

23. A photocatalyst comprising a nanoporous TiO₂ film prepared by the method according to any one of claim 8.

24. An energy conversion device using a photoelectrode according to claim 22.
